(19) United States
(12) Patent Application Publication
(10) Pub. No.: US 2008/0168801 A1
(43) Pub. Date: Jul. 17, 2008

(54) Method of sealing glass

(76) Inventors: Paul Stephen Danielson, Corning, NY (US); Stephan Lvovich Logunov, Corning, NY (US); Kamjula Pattabhirami Reddy, Corning, NY (US)

Correspondence Address: CORNING INCORPORATED, SP-TI-3-1, CORNING, NY, 14831, US

(21) Appl. No.: 11/652,964

(22) Filed: Jan. 12, 2007

(51) Int. Cl. C03B 37/00

(52) U.S. Cl. 65/32.2

(57) ABSTRACT

A method is disclosed for sealing a plurality of glass articles, comprising providing a first glass article comprising at least one first sealing surface, wherein the at least one first sealing surface comprises a glass comprising a copper compound, and optionally a silver compound, positioned within a portion of the glass of the first glass article; providing a second glass article comprising at least one second sealing surface; contacting at least a portion of the first sealing surface with at least a portion of the second sealing surface; and irradiating at least a portion of the first sealing surface in a manner that causes at least a portion of the first glass article and at least a portion of the second glass article to be sealed together. A fused device is also disclosed.

### BACKGROUND OF THE INVENTION

1. Field of the Invention

The present invention relates to a method of sealing glass articles, specifically a method of sealing glass articles through the use of an optically absorbing stain.

2. Technical Background

Glass articles have historically been sealed using a variety of methods. Such methods range from the use of conventional adhesives, to sealing glasses and/or frits, to direct glass to glass sealing by heating and fusing two glass articles together. Direct glass to glass seals obtained by conventional heating and glass working techniques can be durable, but can require that an entire glass article or a substantial portion thereof be heated to a high temperature, typically at least the softening point of the glass. Heating to such high temperatures can be detrimental to delicate glass articles and/or glass devices that comprise thermally sensitive components.

One such device that has gained considerable commercial interest in recent years is a light emitting device, such as an organic light emitting device (OLED). Traditional OLED displays comprise multiple electronic components, such as, for example, a thin organic layer and an electrode layer, positioned between two hermetically sealed glass substrates. The electronic components of an OLED display can be especially susceptible to degradation resulting from exposure to oxygen and/or moisture. Thus, the life of an OLED display can be significantly increased if the electronic components are encapsulated in a hermetically sealed environment and protected from ambient oxygen and moisture. Traditional glass working and sealing techniques to create such a seal would heat the electronic components contained within such a display device beyond the tolerances of the components, resulting in degradation and device failure. For example, the first pixels of an OLED, which are positioned 1-2 mm from the glass seal, should be heated to no more than 100° C. during the sealing process.

As such, there is a need to develop a method to seal glass articles, such as the substrates of a light emitting display, without over-heating the surrounding area and/or electronic components contained therein. These needs and other needs are satisfied by the sealing technology of the present invention.

### SUMMARY OF THE INVENTION

The present invention relates to a method of sealing glass articles, and more particularly to a method of sealing glass articles through the use of an optically absorbing stain.

In a first aspect, the present invention provides a method for sealing a plurality of glass articles comprising providing a first glass article comprising at least one first sealing surface, wherein the at least one first sealing surface comprises a glass comprising a copper compound and optionally a silver compound, positioned within a portion of the glass of the first glass article; providing a second glass article comprising at least one second sealing surface; contacting at least a portion of the first sealing surface with at least a portion of the second sealing surface; and irradiating at least a portion of the first sealing surface in a manner that causes at least a portion of the first glass article and at least a portion of the second glass article to be sealed together.

In a second aspect, the present invention further provides a device comprising at least two glass articles, wherein at least one glass article comprises a sealing area comprising a copper compound and optionally a silver compound, positioned within a portion of the glass of the first glass article, and wherein a second glass article is fused to the at least one glass article through at least a portion of the sealing area.

In another aspect, the present invention provides a device made by the method described above.

Additional aspects and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the present invention and together with the description, serve to explain, without limitation, the principles of the invention. Like numbers represent the same elements throughout the figures.

FIG. 1 illustrates depth profiles of copper concentration for two glass articles prepared in accordance the present invention.

FIG. 2 illustrates a transmission spectrum of a sealing surface stained with copper in accordance with the present invention.

FIG. 3 is a perspective view illustrating two glass articles sealed by a laser, in accordance with one aspect of the present invention.

### DETAILED DESCRIPTION OF THE INVENTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes aspects having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, a “loop”, in reference to a sealing surface, refers to a line that forms a bounded region. The loop line can, for example, intersect with one or more portions of the line forming the bounded region, or can be a continuous line having no beginning or end and also forming a bounded region. A loop can have curved portions, straight portions, and/or corners, and no specific geometry is intended.

As used herein, the term “seal” refers to a direct glass to glass attachment between portions of at least two glass articles in accordance with the present invention. A seal can comprise a single point, multiple points, or a two dimensional area at the interface of at least a portion of each of two glass articles. One or more seals can form a hermetic seal, but the present invention is not intended to be limited to embodiments in which a hermetic seal is formed.

As used herein, a “sealing surface” refers to that portion of the surface of a glass article that is to be sealed to a portion of at least one other glass article and can refer to a stained or unstained portion at any stage of the methods of the present invention.

As used herein, a “stained surface” or “stained sealing surface” refers to that portion of the surface of a glass article that is to be sealed to a portion of at least one other glass article and to which a stain has been applied, regardless of whether or not the surface has been heated or ion exchanged.

As used herein, an “absorbing sealing surface” refers to a sealing surface that has been stained and subsequently heated in a reducing environment, in accordance with the present invention.

The following US Patents describe various staining compositions and methods for staining glass articles, and they are hereby incorporated by reference in their entirety and for the specific purpose of disclosing materials and methods relating to the staining of glass articles: U.S. Pat. Nos. 1,947,781; 2,428,600; 2,486,566; 2,498,003; 2,662,037; 2,701,215; 3,079,264; 3,420,698; 3,424,567; and 4,253,861.

As briefly introduced above, the present invention provides an improved method for directly sealing a plurality of glass articles, such as, for example, the substrates of a light emitting device, through the use of a staining agent and a radiation source. Among other aspects, described in detail below, the staining agent of the present invention comprises at least one copper ion that is capable of exchanging with alkali ions in at least one of the glass articles and providing a stained sealing surface. Upon heating and reduction, the stained sealing surface of the glass article can be optically absorbing. When at least a portion of the absorbing sealing surface is contacted with another glass article, the articles can be sealed by irradiating the absorbing stained sealing surface to soften and fuse the articles together. The stained sealing surface, being more optically absorbing, can absorb more radiation, heat, and soften faster than the surrounding glass, resulting in a direct glass to glass seal without over-heating adjacent glass and/or electronic components. The sealing method of the present invention should be distinguished from the use of a frit seal, wherein a glass frit is used to attach glass articles.

Although various aspects of the present invention are described below with respect to light emitting devices, it should be understood that the same or similar methods can be used in other applications where sealing of a plurality of glass articles is required. Accordingly, the present invention should not be construed in a limited manner.

### Glass Articles

The present invention provides a method for sealing a plurality of glass articles. The glass articles can comprise any glass material suitable for sealing in accordance with various embodiments of the present invention. In various aspects, at least one glass article comprises a borosilicate glass, a soda-lime glass, or a mixture thereof. In one aspect, at least one glass article is a transparent glass. Such transparent glasses can be, for example, those manufactured and sold by Corning Incorporated (Corning, N.Y., USA) under the brand names of Code 7740 glass, Code 1737 glass, Eagle 2000™, and Eagle XG™; Asahi Glass Co., LTD (Tokyo, Japan), for example OA10 glass and OA21 glass; Nippon Electric Glass Co., LTD (Otsu, Shiga, Japan); NH Techno Glass Korea Corporation (Kyunggi-do, Korea); and Samsung Corning Precision Glass Co. (Seoul, Korea). In one aspect, at least one glass article is transparent to radiation at the wavelength of the radiation source used to seal the glass articles. In a preferred aspect, each of the plurality of glass articles of the present invention is comprised of material transparent to radiation at the wavelength of the radiation source used to seal the device.

It is not necessary that the plurality of glass articles be the same or comprise the same type of glass. In one aspect they are similar or identical types of glasses. In a preferred aspect, each of the plurality of glass articles comprises a borosilicate glass, such as a Code 7740 glass. The glass articles can further comprise other materials, such as, for example, ceramics, fillers, and/or processing aids, provided that the other materials do not preclude sealing the articles in accordance with the methods of the present invention.

Other properties of the glass articles will vary depending upon the specific composition thereof. In one aspect, the glass articles of the present invention have a coefficient of thermal expansion (CTE) of from about 25×10⁻⁷/° C. to about 80×10⁻⁷/° C., preferably from about 25×10⁻⁷/° C. to about 40×10⁻⁷/° C. over a temperature range of from about ambient to about 350° C. In another aspect, the softening temperature of the glass articles is from about 970° C. to about 990° C.

The dimensions and geometry of the glass articles can be any such dimensions and geometry suitable for sealing in accordance with the present invention. The glass articles can comprise the same or varying dimensions. Each of the plurality of glass articles comprises at least one sealing surface that can be sealed to another glass article. A sealing surface can comprise a single point or a two-dimensional area on at least one surface of a glass article. In one aspect, the sealing surface of a first glass article is a two dimensional area substantially matched in size and shape to a sealing surface of a second glass article.

An individual glass article can comprise one or more sealing surfaces depending upon the nature of the device being sealed or fabricated. In one aspect, two glass sheets each comprise a sealing surface in the form of a loop, positioned near the edge of the glass sheet. In a specific aspect, at least one of the articles is a glass sheet about 0.6 mm thick and the width of the sealing surface loop (width of the sealing surface itself, not the diameter of the loop) is less than about 2 mm.

### Staining Agent

The staining agent of the present invention can comprise any copper and/or silver containing material capable of exchanging ions with alkali ions, such as, for example, sodium, in at least a portion of a glass article. Such staining agent ions should be optically absorbing in their reduced form, once exchanged with alkali ions in the glass article.

The staining agent can comprise a copper containing compound, such as, for example, a copper halide, sulfide, borate, nitrate, metaphosphate, orthophosphate, pyrophosphate, vanadate, arsenate, antimonate, chromate, selenite, molybdate, tungstate, urinate, hydrate, and/or a combination thereof. In one aspect, the staining agent comprises a copper sulfide. It is preferred that the staining agent comprise a copper chloride. The oxidation state of a copper containing compound can vary and it is not necessary that the copper ion of a particular copper containing compound be in a particular valence state. In various aspects, the staining agent comprises a cuprous chloride, a cupric chloride, or a combination thereof.

The concentration of a copper containing compound in a staining agent can be any concentration capable of providing a stained sealing surface on a glass article. The copper containing compound can comprise from greater than 0 to about 100 wt. %, for example, about 0.5, 1, 2, 4, 6, 10, 15, 20, 25, 30, 40, 50, 60, 70, 80, 90, 95, 99, or 100 wt. % of the staining agent, preferably from about 0.5 to about 25 wt. %, for example, about 0.5, 0.6, 0.75, 1, 2, 3, 5, 7, 9, 12, 15, 18, 21, 23, 24, or 25 wt. % of the staining agent. Copper containing compounds are known in the art and are commercially available (e.g., Sigma-Aldrich, St. Louis, Mo., USA). One of skill in the art could readily select an appropriate copper containing compound for use with the methods of the present invention.

The staining agent of the present invention can optionally comprise other ions, such as, for example, silver, that can be optically absorbing when exchanged with alkali ions in the glass article. Such ions can be provided in any suitable compound, such as, for example, a silver nitrate, a silver oxide, or a combination thereof. The presence of absorbing ions, such as silver, in addition to copper can provide a synergistic effect resulting in greater optical absorbance of a stained sealing surface.

In an alternative aspect, the staining agent of the present invention can comprise a silver containing compound, such as, for example, a silver nitrate, a silver oxide, or a combination thereof, in the absence of a copper containing compound.

The staining agent can further comprise other materials that can impart desired physical, Theological and/or handling properties to the staining agent. Such materials can comprise, for example, ceramics, fillers, and/or solvents. In various aspects, the staining agent can comprise a zircon ceramic, a clay filler, an organic solvent, water, a hydroxide base, or a combination thereof. The staining agent can also comprise sulfur or a sulfur containing compound. Not wishing to be bound by theory, it is believed that the presence of sulfur can improve the staining process.

The staining agent of the present invention can be provided in any physical form suitable for use in staining a portion of a glass article. The staining agent can comprise, for example, a solid, a paste, a slurry, a liquid, a vapor, or a combination thereof. The specific physical form of the staining agent can vary depending upon the application method of the staining agent to the glass article. As such, the specific composition (e.g., copper containing compound) of a staining agent can also vary depending upon the desired physical form and application method. In one aspect, the staining agent is provided in the form of a vapor, such as a volatile copper chloride. In another aspect, the staining agent is provided in the form of a molten salt bath. In another aspect, the staining agent is provided in the form of a paste comprising a copper containing compound and at least one rheological aid. In a specific aspect, a staining agent paste comprises a milled zircon ceramic powder, a clay filler, isopropyl alcohol, water, copper sulfide, sulfur, and lithium hydroxide.

The concentration of the various components of a staining agent can vary depending upon the physical form of the staining agent, the specific components thereof, and the desired amount of ion exchange between the staining agent and alkali ions in the glass article. It is not necessary that any component be present at a specific concentration, only that the staining agent be capable of exchanging ions with alkali ions of the glass article. It is also not necessary that all of the ions of the staining agent exchange with alkali ions of the glass article. The desired amount of ion exchange can be any amount sufficient to provide a stained sealing surface that is more optically absorbing than the unstained portion of the surface. In various aspects, the staining agent apart from the copper containing compound can comprise from about 10 to about 30 wt. % of a milled zircon ceramic; from about 10 to about 30 wt. % of a clay filler; from about 5 to about 60 wt. % of an organic solvent, such as isopropyl alcohol; from about 0 to about 40 wt. % water; from about 0 to about 10 wt. % sulfur; and from about 0 to about 10 wt. % lithium hydroxide. Components, such as ceramics, fillers, and/or solvents are commercially available (e.g., Sigma-Aldrich, St. Louis, Mo., USA) and one of skill in the art could readily select an appropriate component for use in a staining agent in accordance with the present invention.

### Staining of a Glass Article

The staining agent of the present invention can be applied to at least a portion of a glass article in any manner suitable for the glass article and the particular physical form of the staining agent. The staining agent can be applied to a portion of the surface of at least one glass article to create a stained sealing surface. The specific application method can vary depending upon both the physical form of the staining agent and the nature of the surface of the glass article. For example, a vapor phase staining agent can be applied to a sealing surface by exposing the sealing surface to the vapor phase staining agent for a time and temperature sufficient to deposit at least a portion of the staining agent on the sealing surface. Staining agents provided in other physical forms, such as a paste and/or a slurry, can be applied directly to a sealing surface. Such a staining agent can be applied by spreading the staining agent onto the surface of the glass article or by a controlled method, such as screen printing. A controlled method, such as, for example, screen printing, can deposit the staining agent in a defined pattern. In one aspect, a staining agent paste is applied to a portion of the surface of a glass article by a screen printing technique. In a specific aspect, a staining agent paste comprising copper sulfide is be applied to a glass sheet, such as for example, a substrate of a light emitting device, by a screen printing technique in the form of a loop. In another aspect, a mask can be used to isolate a staining agent to a specific portion of a surface, such as a sealing surface.

The amount and/or concentration of a staining agent applied to a portion of the surface of a glass article can vary depending upon the nature of the glass article, the size of the sealing surface, the concentration of copper containing compound in the staining agent, and/or the extent of ion exchange (staining) desired on the sealing surface. The amount of staining agent applied should be a quantity sufficient to facilitate the exchange of at least a portion of the ions of the staining agent with alkali ions in the glass article.

The staining agent of the present invention can be applied to a selected portion of the sealing surface of one glass article, to the entire portion of the sealing surface, to sealing surfaces on each of the glass articles, or a combination thereof. For example, if an edge of a first glass article is to be sealed to an edge of a second glass article, the staining agent can be applied to: a portion of the edge of the first article, for example, in discrete locations along the edge; along the entire edge of the first article; to the edges of both the first and second articles; or a combination thereof. It is not necessary that the staining agent be applied to more than one article.

The stained surface of the glass article can optionally be heated prior to, during, or after application of a staining agent to facilitate ion exchange between the staining agent and alkali ions in the glass article. In one aspect, the surface of the glass article is heated to a temperature below the softening point and/or the deformation temperature of the glass article, such as, for example, from about 900° F. to about 1,100° F., and maintained at that temperature during application of the staining agent. In another aspect, the surface of the glass article is heated to a temperature below the softening point and/or the deformation temperature of the glass article after application of the staining agent. The time and temperature of this optional heating step can vary depending upon the nature of the glass article and the physical form and concentration of the staining agent. In an exemplary aspect, the surface of a stained borosilicate glass article is heated at from about 900° F. to about 1,100° F., preferably at about 1,080° F. for about 90 minutes. This optional heating step can be performed in air or an oxidizing atmosphere. Heating in an atmosphere comprising SO₂ can facilitate more rapid ion exchange between the staining agent and alkali ions in the glass article. It is preferred that the atmosphere comprise SO₂.

After application of a staining agent and optional heating, the stained surface should be heated, in a reducing environment, for a time and to a temperature sufficient to reduce the oxidation state of the exchanged ions in the glass article, but below the deformation temperature of the glass article. The reducing environment can comprise a reducing gas, such as, for example hydrogen and/or a mixture of hydrogen and an inert gas, such as nitrogen. In one aspect, the reducing environment comprises a mixture of about 20 mole % hydrogen and about 80 mole % nitrogen. The reducing environment can also comprise the use of a reducing material, such as, for example, sawdust and/or charcoal, positioned on the stained portion of the surface of the glass article during heating. The time and temperature of heating in a reducing environment can vary depending upon the nature of the glass article, the composition of the staining agent, and the degree of ion exchange desired. The time and temperature can range from about 900° F. to about 1,100° F. and be for a period of at least about 30 minutes. In one aspect, the time and temperature of heating in a reducing environment is at about 1,080° F. for about 90 minutes.

After heating in a reducing environment, the staining agent ions exchanged into the glass article should be present in a reduced form. Any staining agent remaining on the surface of a glass article, after heating, can be removed by, for example, washing. Staining agent left on the surface of a glass article will not contribute to the sealing process and can prevent a durable seal from forming between the glass articles.

Staining techniques and application methods are known in the art and can be performed commercially (e.g., Jafe Decorating Company, Greenville, Ohio, USA). One of skill in the art could readily select an appropriate staining method for a particular application and/or device.

### Properties of Stained Glass Article

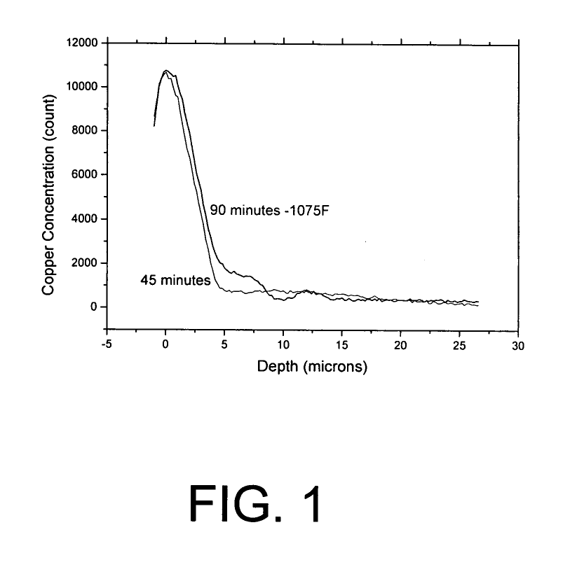

An absorbing sealing surface comprises within the surface portion of the glass at least a portion of the copper and other absorbing ions from the staining agent. After reduction, the portion of a stained sealing surface that comprises ions from the staining agent, such as, for example, copper, can extend from the stained surface to a depth of from about 1 to about 20 μm, for example, about 1, 2, 4, 5, 6, 7, 10, 12, 15, 18, or 20 μm. Typical depths of up to about 4 to about 10 μm can be easily achieved and can be effective for sealing glass articles in accordance with the methods of the present invention. FIG. 1 illustrates depth profiles of copper concentration for two glass articles prepared in accordance the present invention. Each of the samples illustrated in FIG. 1 comprised a decreasing concentration of copper from the surface to a depth of about 4-5 μm.

An absorbing sealing surface should exhibit an optical absorbance greater than the surrounding unstained surface. This optical absorbance should preferably be high at the wavelength of the radiation source used to seal the articles. A copper stained glass article will typically exhibit a red color. For the purposes of this invention, absorbance can be defined as follows:

β=−log₁₀[T/(1−R)²]/t,

wherein β refers to the absorption coefficient, T refers to the fraction of light transmitted through thickness t, and R refers to reflectance.

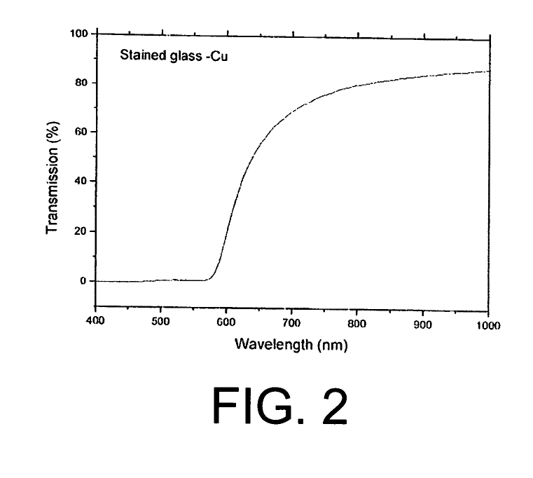

The absorption coefficient of the absorbing sealing surface should be greater than about 2/mm at the radiation wavelength. In one aspect, the absorption coefficient of the absorbing sealing surface is about 2/mm. In a preferred aspect, the absorption coefficient of the absorbing sealing surface is at least about 4/mm. FIG. 2 illustrates a transmission spectrum of an absorbing sealing surface stained with copper in accordance with the present invention. The absorbing sealing surface exhibits high absorption at wavelengths less than about 575 nm.

### Sealing

One or more glass articles can be fused, or sealed together, by contacting at least one absorbing sealing surface with at least one sealing surface, and irradiating at least a portion of the absorbing sealing surface. It is not necessary that more than one sealing surface be absorbing in accordance with the present invention. In one aspect, each of two sealing surfaces to be sealed are absorbing sealing surfaces, stained and reduced according the various aspects of the present invention. In another aspect, two sealing surfaces are to be sealed, wherein only one sealing surface is an absorbing sealing surface. It is preferred that only one sealing surface be an absorbing sealing surface and that the remaining sealing surfaces be transparent, unstained glass so as to allow radiation to more effectively reach the absorbing sealing surface.

The absorbing sealing surface can be heated by a radiation source, such as, for example, a laser, in a manner so that the absorbing sealing surface is heated and softens, forming a direct glass to glass seal between the absorbing sealing surface and the one or more sealing surfaces in contact therewith. The absorbing sealing surface can be heated using a variety of radiation sources such as a laser or an infrared lamp. In a preferred aspect, the radiation source comprises a laser that can emit radiation at a wavelength corresponding to the absorbing sealing surface.

An advantage of the present invention is that when using, for example, a laser to irradiate an absorbing sealing surface, the absorbing sealing surface can be rapidly heated while the surrounding unstained portion of the glass article remains at or close to ambient conditions.

An absorbing sealing surface that has been irradiated can swell and expand in volume, creating a raised area on the surface of the glass article. Such swelling can result in a height change of up to about 5 μm, for example, about 0.5, 1, 2.5, or 5 μm. The specific height change, if any, that an absorbing sealing surface will exhibit can vary depending upon the absorption coefficient and the depth to which ions from the staining agent exist in the glass.

Depending on the physical and optical properties of a particular glass article and absorbing sealing surface, at least a portion of the raised height of a swollen absorbing sealing surface can be maintained if the sealing surface is cooled quickly. Such quick cooling can cause the absorbing sealing surface to have a lower density than the surrounding glass. A raised area can be beneficial, for example, when sealing the glass sheet substrates of a light emitting display by creating an encapsulated region between the plates for the thin organic film and electronics of such a device.

### Radiation Source

The radiation source of the present invention can be any radiation source which emits radiation at a wavelength corresponding to the absorbing sealing surface. For example, an absorbing sealing surface comprising copper can be heated with a laser operating at a wavelength of from about 520 nm to about 545 nm, or from about 340 nm to about 370 nm. The laser preferably emits radiation at about 532 nm, 355 nm, or at both 532 nm and 355 nm.

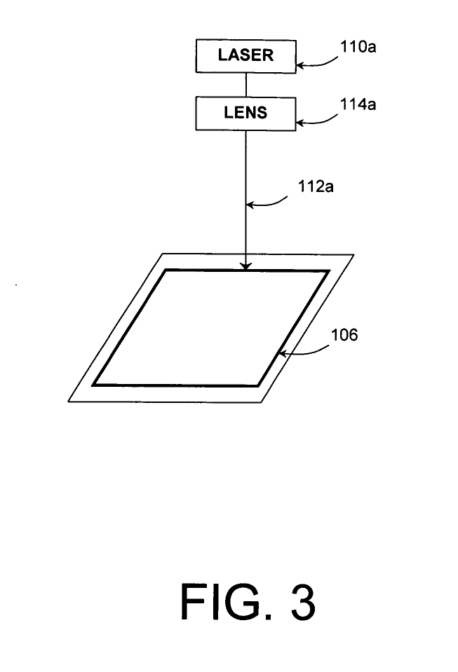

The laser 110 can comprise additional optical components, as depicted in FIG. 3, such as a lens 114a, to direct or focus the laser beam 112a onto an absorbing sealing surface 106. The laser beam can be moved in a manner to effectively heat and soften an absorbing sealing surface, while at the same time minimizing heating of adjacent portions of the glass article and any optional electronic components.

It should be readily appreciated that depending on the optical properties of the particular absorbing sealing surface, other types of lasers can be used that operate at different powers, different speeds and different wavelengths. However, the laser wavelength should be within a band of high absorption for the particular absorbing sealing surface. In various aspects, the laser can provide from about 5 to about 15 W, preferably from about 8 to about 10 W of laser power, and can be moved along a sealing surface at a speed of from about 3 to about 10 mm/s, preferably about 5 mm/s. One of skill in the art could readily select an appropriate laser for a particular absorbing sealing surface.

It should be noted that there are many different types of optical arrangements which could be used, and the present invention is not intended to be limiting to a particular optical arrangement.

It should be emphasized that the present invention does not require that a seal be hermetic. A seal can refer to a single fused point between two glass articles, to a continuous line or seal attaching at least two glass articles, or to a seal, such as a hermetic seal, that forms an encapsulated area.

The methods of the present invention also do not require any material, such as a heat sink, to be placed between the sealing surfaces of two glass articles, nor the use of any other sealing material, such as an adhesive, a sealing glass, or a frit. If desired, a sealing material, such as an adhesive, a sealing glass, or a frit can be used as a supplemental seal in addition to the direct glass to glass seal of the present invention.

Although several aspects of the present invention have been illustrated in the accompanying drawings and described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Preparation of Staining Agent

In a first example, two staining agents were prepared by combining the components listed in Table 1 below. The components of each staining agent were uniformly mixed to form a staining agent paste.

TABLE 1
Copper Staining Agents

| Component, wt. % | A | B |
|---|---|---|
| Milled Zircon | 19.69 | 19.69 |
| Clay | 19.69 | 19.69 |
| Isopropyl Alcohol | 38.35 | 38.35 |
| Water | 5.23 | 5.23 |
| CuS | 14.82 | 14.82 |
| Sulfur | 1.48 | 1.48 |
| LiOH | 0.74 | 0 |
| CuCl | 0 | 0.74 |

### Example 2

### Application of Staining Agent

In a second example, a staining agent (“A”) prepared in Example 1 was dispensed in a loop pattern onto the surface of a piece of borosilicate glass sheet using a screen printing technique. The stain was allowed to dry and the stained glass sheet fired at 1,080° F. in an oxidizing gas (SO₂) for 90 minutes and then in a reducing gas (20 mole % H₂+80 mole % N₂) for 90 minutes. After firing, the portion of the staining agent remaining on the surface was washed off. The depth profile of copper concentration in the stained borosilicate glass sheet is illustrated in FIG. 1.

Throughout this application, various publications are referenced. The disclosures of these publications in their entireties are hereby incorporated by reference into this application in order to more fully describe the compositions, articles, device, and methods described herein.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

### Example 3

### Sealing of a Staining Glass Article (Prophetic)

In a third example (prophetic), a glass article stained and reduced according to the procedure of Example 2 is sealed to another glass article. The stained sealing surface loop of the first glass sheet is contacted with an unstained glass sheet, and laser radiation at a wavelength of 532 nm (9.5 W laser, 0.7 mm spot size) is scanned across the stained sealing surface at a rate of 5 mm/s, creating a direct glass to glass seal between the two glass sheets.

What is claimed is:

1. A method for sealing a plurality of glass articles, comprising:
a) providing a first glass article comprising at least one first sealing surface, wherein the at least one first sealing surface comprises a glass comprising a copper compound and optionally a silver compound, positioned within a portion of the glass of the first glass article;
b) providing a second glass article comprising at least one second sealing surface;
c) contacting at least a portion of the first sealing surface with at least a portion of the second sealing surface; and
d) irradiating at least a portion of the first sealing surface in a manner that causes at least a portion of the first glass article and at least a portion of the second glass article to be sealed together.

2. The method of claim 1, wherein step a) comprises:
providing a first glass article comprising at least one first sealing surface,
contacting a staining agent comprising a copper compound and optionally a silver compound with at least a portion of the at least one first sealing surface, and
heating, in a reducing environment, the portion of the at least one first sealing surface contacted with the staining agent, such that the at least one first sealing surface comprises a glass comprising a copper compound and optionally a silver compound, positioned within a portion of the glass of the first glass article.

3. The method of claim 1, wherein the at least one second sealing surface comprises a glass comprising a copper compound and optionally a silver compound, positioned within a portion of the glass of the second glass article.

4. The method of claim 2, wherein the staining agent comprises a paste, a slurry, a solution, a molten salt bath, or a combination thereof.

5. The method of claim 2, wherein the staining agent comprises a copper compound and a silver compound.

6. The method of claim 5, wherein the staining agent comprises a copper halide.

7. The method of claim 2, wherein the reducing environment comprises hydrogen.

8. The method of claim 2, wherein the staining agent is contacted in the form of a loop.

9. The method of claim 1, wherein the first glass article comprises a borosilicate glass having a coefficient of thermal expansion of from about 25×10⁻⁷/° C. to about 40×10⁻⁷/° C.

10. The method of claim 1, wherein at least a portion of the at least one first sealing surface has an absorption coefficient of radiation of at least about 2/mm at 532 nm.

11. The method of claim 1, wherein a hermetic seal is formed between the first glass article and the second glass article enclosing an encapsulated area.

12. The method of claim 11, wherein the encapsulated area comprises at least a portion of a light emitting device.

13. The method of claim 1, wherein the irradiating comprises laser irradiation.

14. The method of claim 1, wherein the irradiating comprises exposing at least a portion of the first sealing surface to radiation of from about 520 nm to about 545 nm, of from about 340 nm to about 370 nm, or a combination thereof.

15. A glass device produced by the method of claim 1.

16. A hermetically sealed device produced by the method of claim 11.

17. A light emitting device produced by the method of claim 12.

18. A device comprising at least two glass articles, wherein a first glass article comprises a sealing area comprising a copper compound and optionally a silver compound, positioned within a portion of the glass of the first glass article, and
wherein a second glass article is fused to the a first glass article through at least a portion of the sealing area.

19. The device of claim 18, wherein both the first glass article and the second glass article comprise a sealing area comprising a copper compound.

20. The device of claim 18, wherein the first glass article comprises a sealing area comprising a copper compound and a silver compound.
